(19) United States
(12) Patent Application Publication
(10) Pub. No.: US 2012/0059909 A1
(43) Pub. Date: Mar. 8, 2012

(54) Information processing apparatus, communication control method, and computer-readable recording medium storing communication control program

(75) Inventor: Hiroyuki Sato, Kawasaki (JP)

(73) Assignee: FUJITSU LIMITED, Kawasaki (JP)

(21) Appl. No.: 13/373,242

(22) Filed: Nov. 9, 2011

Related U.S. Application Data
(63) Continuation of application No. PCT/JP2009/059278, filed on May 20, 2009.

(51) Int. Cl. G06F 15/16

(52) U.S. Cl. 709/217

(57) ABSTRACT

In an information processing apparatus, a storage unit stores a keyword according to executed information processing. A communication unit transmits a message specifying a server device as a destination and receives data according to the message from the server device via a network. A controller adds at least one of the keywords stored in the storage unit to a message to a predetermined server device among the messages transmitted by the communication unit.

This application is a continuing application, filed under 35 U.S.C. §111(a), of International Application PCT/JP2009/059278, filed on May 20, 2009.

### FIELD

The embodiment discussed herein is related to an information processing apparatus, a communication control method, and a computer-readable recording medium storing a communication control program.

### BACKGROUND

At present, various data can be acquired from other information processing devices by using an information processing device connected to a network. The information processing device as a client device can access the information processing device as a server device and acquire data managed by the server device via a network. Examples of a client server distributed data management system include a world wide web (WWW) which transmits and receives data according to a hypertext transfer protocol (HTTP).

Here, multiple server devices accessible from a client device are used. Also, a server device which manages a large variety of data is used. For example, a server device used for an electronic commerce may manage large commodity data. Accordingly, a user can preferably use a way to facilitate retrieval and acquisition of desired data.

With regard to retrieval of commodity data, there is disclosed a database server which presents a frequently-used keyword to a user and retrieves commodity information by using the keyword selected by the user (see, e.g., International Publication Pamphlet No. WO 2002-025491). Further, there is disclosed an electronic commerce server which stores previous purchases of users and presents a successor commodity being compatible with a previous purchase commodity to a user (see, e.g., Japanese Laid-open Patent Publication No. 2004-326502).

With regard to retrieval of a so-called website, there is disclosed a system which extracts property information from music data downloaded by a portable terminal device and retrieves a website related to the property information (see, e.g., Japanese Laid-open Patent Publication No. 2007-299336). Further, with regard to a creation of a search query, there is disclosed a device which identifies multiple documents simultaneously referenced by a user and automatically creates a search query from the above document group (see, e.g., see Japanese Laid-open Patent Publication No. 2008-33687 (paragraph number [0033])).

As described before, it is preferred that a user can swiftly acquire desired data from among data managed by the server device. However, there is a problem that in a method disclosed in International Publication Pamphlet No. WO 2002-025491, since the user explicitly operates retrieval, the time is required until reaching the desired data. Further, there is a problem that in a method disclosed in Japanese Laid-open Patent Publication No. 2004-326502, since history information of the server device side is used, it is difficult to present appropriate data to a user with poor use results.

### SUMMARY

According to one aspect of the present invention, an information processing apparatus includes a storage unit configured to store a keyword according to executed information processing; a communication unit configured to transmit a message specifying a server device as a destination and receive data according to the message from the server device via a network; and a controller configured to add at least one of the keywords stored in the storage unit to a message to a predetermined server device among the messages transmitted by the communication unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of an information processing apparatus according to the present embodiment;

FIG. 2 illustrates the entire configuration of an electronic commerce system;

FIG. 3 is a block diagram illustrating hardware of a client device;

FIG. 4 is a block diagram illustrating a function of a client device;

FIG. 5 is a block diagram illustrating hardware of a server device;

FIG. 6 is a block diagram illustrating a function of a server device;

FIG. 7 illustrates a data structure of a keyword information table;

FIG. 8 illustrates a data structure of a request message;

FIG. 9 illustrates a data structure of a commodity information table;

FIG. 10 is a flowchart illustrating control of a client device;

FIG. 11 illustrates an extraction example of a keyword;

FIG. 12 is a flowchart illustrating control of a server device; and

FIG. 13 illustrates a display screen example.

### DESCRIPTION OF EMBODIMENTS

Preferred embodiments of the present invention will now be described in detail below with reference to the accompanying drawings, wherein like reference numerals refer to like elements throughout.

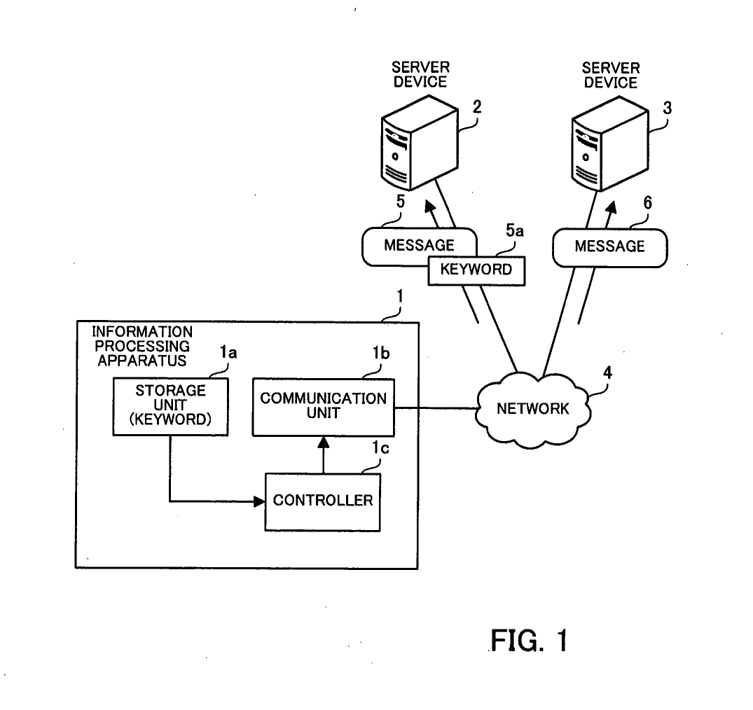

FIG. 1 illustrates an example of an information processing apparatus according to the present embodiment. The illustrated information processing apparatus 1 is connected to a network 4, and can communicate with server devices 2 and 3 via the network 4. The information processing apparatus 1 includes a storage unit 1a, a communication unit 1b, and a controller 1c.

The storage unit la storages a keyword according to executed information processing (for example, information processing executed by the information processing apparatus 1 upon receiving operations from a user). A keyword is, for example, extracted by the controller 1c and sequentially stored in the storage unit 1a. The storage unit 1a may store multiple keywords. For the purpose of selecting a keyword, the storage unit 1a may further store a type of information processing and a date at which the keyword is acquired correspondingly to the keyword.

Examples of the information processing include data communication with a server device providing a website service, reproduction of music data or video data, and execution of other application software. In the case of the data communication, for example, a keyword can be extracted from a transmitted retrieval word or received text document. When reproducing music data or video data, a keyword can be extracted from attribute data of data to be reproduced. When executing the application software, a keyword can be extracted from a name of the software.

Via the network 4, the communication unit 1b transmits messages 5 and 6 specifying the server device as a destination. Examples of the messages 5 and 6 include an HTTP request. The server device as a destination can be specified, for example, by using a host name or Internet Protocol (IP) address. Further, the communication unit lb receives data according to the messages 5 and 6 from the server devices 2 and 3 via the network 4. Examples of the received data include text data and image data.

Among the messages 5 and 6 transmitted by the communication unit 1b, the controller 1c adds the keyword (e.g., the keyword 5a) stored in the storage unit 1a to the message 5 to the predetermined server device 2. As a result, the controller 1c can acquire data selected depending on the added keyword among data managed by the predetermined server device 2. The controller 1c may add only one keyword or multiple keywords. Further, the controller 1c may add all the keywords stored in the storage unit 1a, or narrow into a part of the keywords for addition.

In the above-described information processing apparatus 1, the storage unit 1a stores the keyword according to the executed information processing. Via the network 4, the communication unit 1b transmits the messages 5 and 6 specifying the server device as a destination, and the server devices 2 and 3 receive data according to the messages 5 and 6. Among the messages 5 and 6 transmitted by the communication unit 1b, the controller 1c adds at least one of the keywords stored in the storage unit la to the message 5 to the predetermined server device 2.

This processing permits the information processing apparatus 1 to automatically transmit a keyword on which an interest of a user is reflected during access to the predetermined server device 2. As a result, desired data of the user can be easily acquired from the server device 2, and a burden of data retrieval operation of the user is relieved. Such a communication control method is effective also for the server device having no access result of the user.

It is assumed here that the server device 2 is a web server device providing an electronic commerce site. When transmitting a message including a predetermined address (e.g., a root address of the electronic commerce site), the information processing apparatus 1 receives screen data (e.g., commodity classification list) for retrieving commodity data managed by the server device 2. At this time, the information processing apparatus 1 receives also commodity data based on the keyword added to the message from the server device 2. As a result, the user can receive a presentation of commodities considered to have a high interest of the user also before performing a retrieval operation.

An example of applying the above-described communication control method to an electronic commerce system will be described in more detail below. Note that the communication control method can be applied also to various usages except a usage of the electronic commerce system.

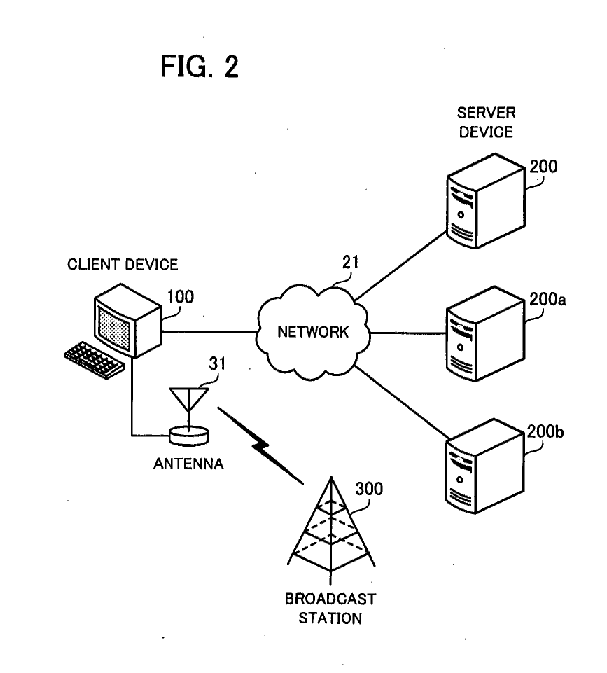

FIG. 2 illustrates the entire configuration of the electronic commerce system. The electronic commerce system according to the present embodiment has a client device 100, server devices 200, 200a, and 200b, and a broadcast station 300. The client device 100 and the server devices 200, 200a, and 200b are connected to a network 21. Further, the client device 100 is connected to an antenna 31.

The client device 100 is an information terminal device operable by the user. Examples of the client device 100 include a desktop computer, a notebook computer, and a portable terminal device. The client device 100 communicates with the server devices 200, 200a, and 200b via the network 21. Further, the client device 100 receives a television signal from the broadcast station 300 via the antenna 31. In addition, the client device 100 can execute various application software programs while receiving operations of the user.

Each of the server devices 200, 200a, and 200b is an information processing apparatus performing data processing and data transmission according to an access from the client device 100. The server device 200 provides an electronic commerce site. The server device 200a provides a retrieval site. The server device 200b provides an electronic commerce site different from that of the server device 200. Data processed by each server device may be stored in the storage device thereof, or in an external storage device (not illustrated) (e.g., a database server device).

The broadcast station 300 is a wireless transmission equipment which transmits a television signal. The broadcast station 300 codes and modulates video data of television broadcast programs, thus transmitting it via radio waves. A television signal output by the broadcast station 300 is received by the antenna 31 and supplied to the client device 100. In addition, the client device 100 may use a cable television broadcast in place of TV broadcasting.

The following section will now discuss the case where the electronic commerce system according to the present embodiment is realized by using a technology of WWW. Specifically, the server devices 200, 200a, and 200b are mounted as a web server device. Further, the client device 100 is mounted as a web client device which executes a web browser. Note that the electronic commerce system as illustrated in FIG. 2 can also be realized by adopting a communication technology except a technology of WWW.

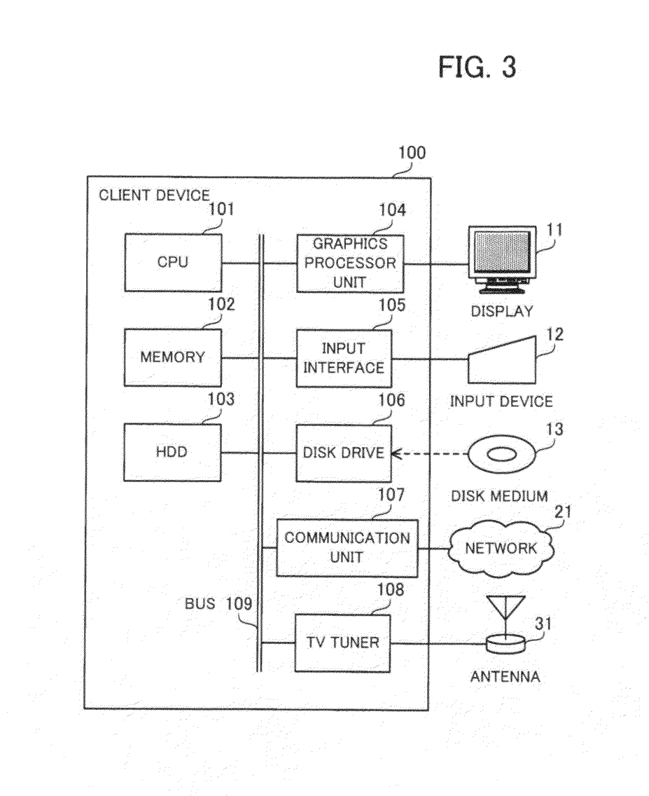

FIG. 3 is a block diagram illustrating hardware of the client device. The client device 100 has a central processing unit (CPU) 101, a memory 102, a hard disk drive (HDD) 103, a graphics processor unit 104, an input interface 105, a disk drive 106, a communication unit 107, and a TV tuner 108. The respective units are connected to a bus 109.

The CPU 101 controls the entire client device 100. The CPU 101 reads out a program stored in the HDD 103, develops it to the memory 102, and executes it. Specifically, the CPU 101 starts the execution of an operating system (OS) program during start of the client device 100, and executes an application program in response to subsequent operations of the user. Note that multiple CPUs may be mounted on the client device 100 and distributed processing may be performed.

The memory 102 temporarily stores at least part of a program executed by the CPU 101 and data used for processing through the CPU 101. Examples of the memory 102 include a random access memory (RAM). The CPU 101 appropriately reads and writes a program and data with respect to the memory 102.

The HDD 103 stores a program executed by the CPU 101 and data used for processing through the CPU 101. Examples of the program stored in the HDD 103 include an OS program and an application program such as a program of web browser and a program for viewing TV broadcasting. A nonvolatile memory device such as a solid state drive (SSD) may be used in place of (or in conjunction with) the HDD 103.

The graphics processor unit 104 is connected to a display 11. The graphics processor unit 104 produces an image signal of a display screen and supplies the image signal to the display 11 according to control of the CPU 101. The display screen includes a window according to an application program during the execution.

The input interface 105 is connected to an input device 12. Examples of the input device 12 include a keyboard, a mouse, a touch pad, and a touch panel. The input interface 105 detects an operation (e.g., a depression of the key) of the user with respect to the input device 12, and supplies an input signal to the CPU 101.

The disk drive 106 is a drive unit which reads data from a disk medium 13 as a portable recording medium. Examples of the disk medium 13 include a magnetic disk such as a flexible disk (FD), an optical disk such as a compact disk (CD) and a digital versatile disk (DVD), and a magneto-optical disk (MO). On the disk medium 13, for example, music data or video data is recorded.

The communication unit 107 is connected to the network 21. The communication unit 107 communicates with the server devices 200, 200a, and 200b according to the control of the CPU 101. Specifically, the communication unit 107 codes and modulates transmit data and outputs it to the server devices 200, 200a, and 200b. Further, the communication unit 107 demodulates and decodes data received from the server devices 200, 200a, and 200b. The communication unit 107 may be connected to the network 21 via a wireless access network.

The TV tuner 108 is connected to the antenna 31. The TV tuner 108 acquires a television signal from the antenna 31, and extracts a signal of a frequency band corresponding to a channel to be viewed. The TV tuner 108 performs demodulation and decoding and acquires video data of the television broadcast program. The channel to be viewed is specified from the CPU 101.

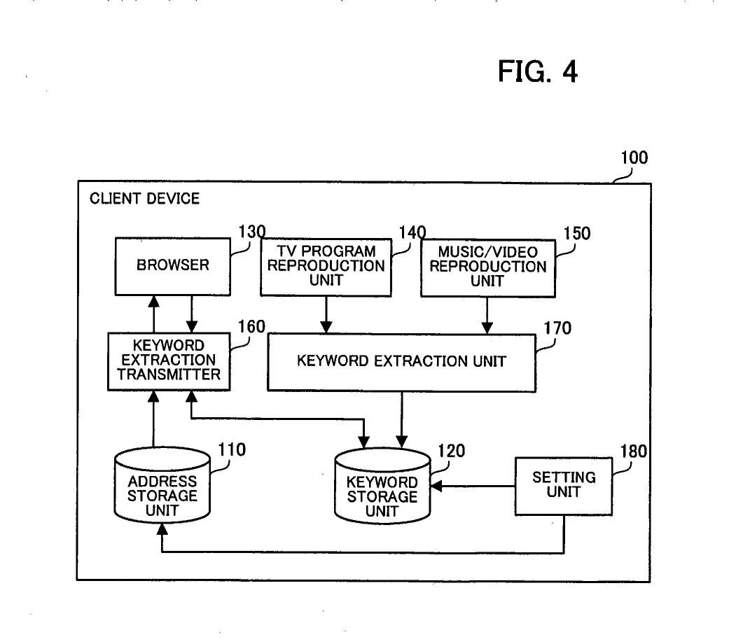

FIG. 4 is a block diagram illustrating a function of the client device. On the client device 100, an address storage unit 110, a keyword storage unit 120, a browser 130, a TV program reproduction unit 140, a music/video reproduction unit 150, a keyword extraction transmitter 160, a keyword extraction unit 170, and a setting unit 180 are mounted. When the CPU 101 executes a program, functions of these modules are realized. Note that a part or all of the modules may be realized by using an exclusive hardware circuit.

The address storage unit 110 stores an address of a web site as an object for performing predetermined processing. Specifically, the address storage unit 110 stores an address indicating an extraction processing object of the keyword and an address indicating an automatic addition object of the keyword. For example, an address is described by using a uniform resource locator (URL) format. The address stored in the address storage unit 110 includes one previously defined fixedly and one set by the setting unit 180.

The keyword storage unit 120 stores a keyword featuring an interest of the user of the client device 100. The keyword storage unit 120 can store multiple keywords. Examples of the keyword stored in the keyword storage unit 120 include one extracted by the keyword extraction transmitter 160, one extracted by the keyword extraction unit 170, and one set by the setting unit 180.

The browser 130 acquires data managed by the server devices 200, 200a, and 200b, and provides a user interface for browsing the data. Specifically, the browser 130 transmits an HTTP request to the server devices 200, 200a, and 200b in response to operations of the user. Further, the browser 130 receives an HTTP response as a reply to the HTTP request and displays data (e.g., text data and image data) included in the HTTP response.

The TV program reproduction unit 140 provides a user interface for viewing a television broadcast program. Specifically, the TV program reproduction unit 140 specifies the channel to be viewed to the TV tuner 108 in response to a channel select operation of the user, and acquires and displays video data of the specified channel. Further, the TV program reproduction unit 140 acquires and displays program information giving an outline of the television broadcast program. Examples of the program information include one multiplexed to video data to be transmitted by the broadcast station 300. Or, the TV program reproduction unit 140 acquires the program information via the network 21 from the web site providing the program information.

The music/video reproduction unit 150 reproduces content data such as music data and video data in response to operations of the user. For example, the music/video reproduction unit 150 reproduces data recorded on the HDD 103 or disk medium 13. On this occasion, the music/video reproduction unit 150 acquires and displays attribute data added to the content data. Examples of the attribute data include a title, a genre, an artist name, and a performer name.

The keyword extraction transmitter 160 monitors an input and output message of the browser 130, and performs extraction processing and addition processing of the keyword with respect to the message including an address stored in the address storage unit 110. Specifically, the keyword extraction transmitter 160 detects an HTTP request and HTTP response including an address as an extraction processing object, extracts a keyword, and stores it in the keyword storage unit 120. Further, the keyword extraction transmitter 160 detects an HTTP request including an address as an addition processing object, and adds the keyword stored in the keyword storage unit 120 to the HTTP request.

The keyword extraction transmitter 160 may detect the HTTP request and the HTTP response by monitoring an execution process of the browser 130, or monitoring data transmission/reception of the communication unit 107. Further, the keyword extraction transmitter 160 may perform the addition processing of the keyword after waiting for a request from the server device as a transmission destination.

The keyword extraction unit 170 monitors an execution process of the TV program reproduction unit 140, the music/video reproduction unit 150, and other application software, extracts a keyword, and stores it in the keyword storage unit 120. The execution process to be monitored is considered to be previously registered in the keyword extraction unit 170.

For example, the keyword extraction unit 170 detects a viewing of the television broadcast program, and extracts a keyword from program information about the viewed television broadcast program. The keyword extraction unit 170 may acquire the program information from the TV program reproduction unit 140, or from a web site via the network 21. Note that the keyword extraction unit 170 can detect a viewing of the television broadcast program also by monitoring operations of the TV tuner 108.

Further, the keyword extraction unit 170 detects reproduction of the content data, and detects a keyword from attribute data of the content data. The keyword extraction unit 170 may acquire the attribute data from the music/video reproduction unit 150, or may acquire the attribute data directly from the content data. In addition, the keyword extraction unit 170 can also monitor execution of various application software such as game software and image edit software. In that case, for example, the keyword extraction unit 170 is considered to extract a name of the executed software as the keyword.

The setting unit 180 provides the user interface for setting an address and a keyword. When the user inputs an address indicating an object of the extraction processing or addition processing, the setting unit 180 stores the input address in the address storage unit 110. Further, when the user inputs the keyword, the setting unit 180 stores the input keyword in the keyword storage unit 120.

In addition, the address and keyword can be stored in a file of the HDD 103. The browser 130, the TV program reproduction unit 140, and the music/video reproduction unit 150 can be realized as separate application software, respectively. The keyword extraction unit 170 can be realized as resident software being automatically started after the start of the OS. The keyword extraction transmitter 160 can be realized as software (add-in) to be incorporated into the browser 130.

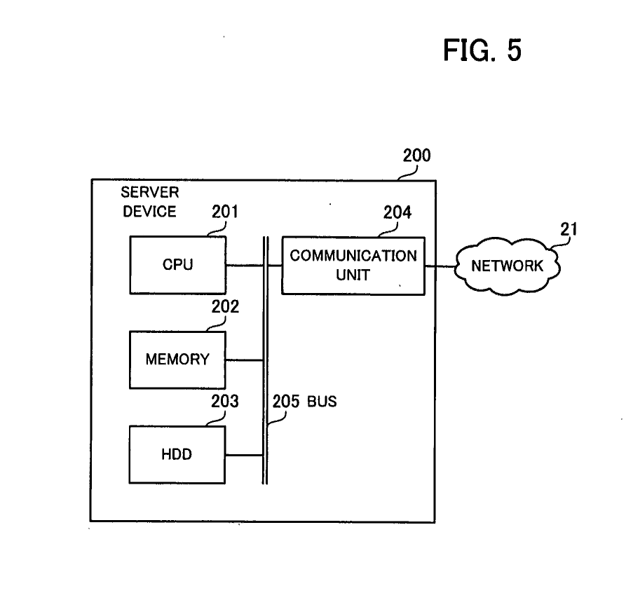

FIG. 5 is a block diagram illustrating hardware of the server device. The server device 200 has a CPU 201, a memory 202, an HDD 203, and a communication unit 204. The respective units are connected to a bus 205. Also, the server devices 200a and 200b can be realized by using the same hardware configuration as that of the server device 200.

The CPU 201 controls the entire server device 200. The CPU 201 reads a program stored in the HDD 203, and develops it to the memory 202, and executes it. Specifically, during start of the server device 200, the CPU 201 starts the execution of the OS program. The CPU 201 then starts the execution of a program of the web server for processing access from the client device 100. Note that multiple CPUs may be mounted on the server device 200, and distributed processing may be performed.

The memory 202 temporarily stores at least part of a program executed by the CPU 201 and data used for processing through the CPU 201. Examples of the memory 202 include a RAM. The CPU 201 appropriately reads and writes a program and data with respect to the memory 202.

The HDD 203 stores a program executed by the CPU 201 and data used for processing through the CPU 201. Examples of the program stored in the HDD 203 include an OS program and an application program such as a program of the web server and a program for data retrieval. A nonvolatile memory device such as an SSD may be used in place of (or in conjunction with) the HDD 203.

The communication unit 204 is connected to the network 21. The communication unit 204 communicates with the client device 100 according to the control of the CPU 201. Specifically, the communication unit 204 demodulates and decodes data received from the client device 100. Further, the communication unit 204 codes and modulates transmit data, and outputs it to the client device 100.

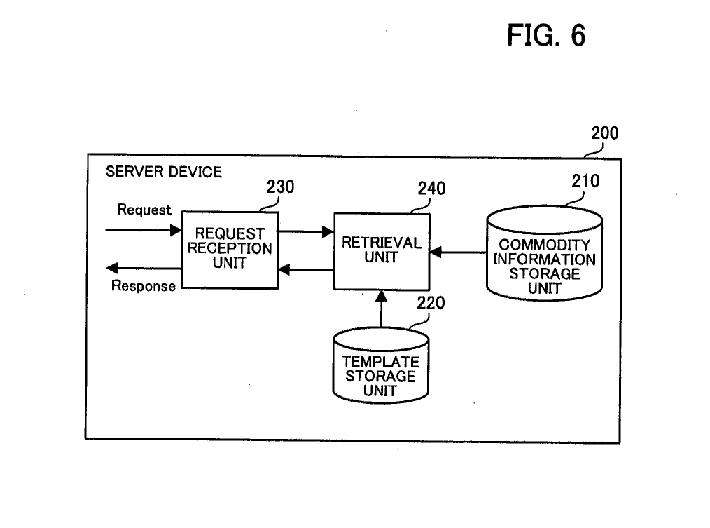

FIG. 6 is a block diagram illustrating a function of the server device. On the server device 200, a commodity information storage unit 210, a template storage unit 220, a request reception unit 230, and a retrieval unit 240 are mounted. When the CPU 201 executes a program, functions of these modules are realized. Note that a part or all of the modules may be realized by using an exclusive hardware circuit.

The commodity information storage unit 210 stores data of commodities handled in electronic commerce by the server device 200. Examples of the commodity data include text data describing commodities and image data illustrating appearances of commodities. Further, the commodity information storage unit 210 stores data used for the retrieval of commodities, such as a keyword related to each commodity. In the commodity information storage unit 210, data can be stored by using various formats such as a relation table and an extensible markup language (XML).

The template storage unit 220 stores a form of HTML data to be transmitted to the client device 100, namely, an HTML template. The HTML template defines a method of displaying the commodity data. When text data is embedded in the HTML template, the template storage unit 220 can produce the HTML data.

The request reception unit 230 processes an HTTP request and an HTTP response. Specifically, when receiving the HTTP request from the client device 100, the request reception unit 230 requests a process according to an address specified by the HTTP request to the retrieval unit 240. When a keyword is added to the HTTP request, the request reception unit 230 extracts the keyword and supplies it to the retrieval unit 240. When acquiring data on the processing result from the retrieval unit 240, the request reception unit 230 then produces the HTTP response and transmits it to the client device 100.

The retrieval unit 240 receives a request from the request reception unit 230, and acquires commodity data from the commodity information storage unit 210. When receiving a keyword from the request reception unit 230, the retrieval unit 240 performs retrieval by using the keyword and narrows down the acquired commodity data. The retrieval unit 240 then produces HTML data from the text data as commodity data and the HTML template stored in the template storage unit 220, and supplies the HTML data to the request reception unit 230. Further, the retrieval unit 240 supplies image data as commodity data to the request reception unit 230.

The commodity data and the HTML template can be stored in a file of the HDD 203. The request reception unit 230 can be realized as resident software. The retrieval unit 240 may be started when receiving a request from the request reception unit 230, or the retrieval unit 240 may be always started. In the latter case, for each request, the retrieval unit 240 may produce a thread for processing the request.

Examples of the HTML data output by the server device 200 include data indicating details of individual commodities and data (e.g., a commodity classification list) for finding out a desired commodity through a user. For example, the server device 200 outputs the former when receiving an HTTP request specifying an address corresponding to each commodity. For example, the server device 200 outputs the latter when receiving an HTTP request specifying a root address (e.g., a front page address) of an electronic commerce site.

Note that when a keyword is added to the HTTP request, the server device 200 can output the HTML data including also commodity data corresponding to the keyword. Processing for automatically outputting the commodity data corresponding to the keyword may be performed only with respect to the HTTP request specifying a root address, or with respect to the HTTP request specifying an arbitrary address in an electronic commerce site.

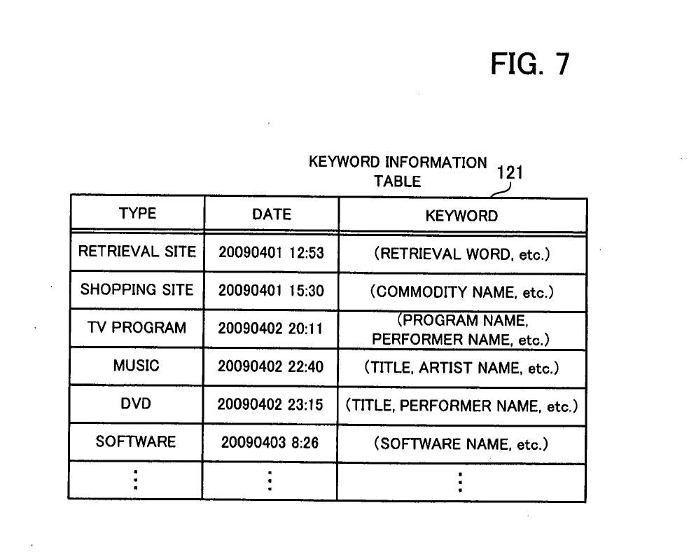

FIG. 7 illustrates a data structure of a keyword information table. The keyword information table 121 is stored in the keyword storage unit 120 of the client device 100. To the keyword information table 121, data is appropriately added by the keyword extraction transmitter 160, the keyword extraction unit 170, and the setting unit 180.

The keyword information table 121 includes items of the type, the date, and the keyword. In the item of the type, a type of information processing being an acquisition cause of the keyword is set. In the item of the date, a date at which the keyword is acquired is set. In the item of the keyword, one or more acquired keywords are set. For example, when multiple keywords are set, they are separated by commas.

For example, when transmitting a retrieval word to the server device 200a providing a retrieval site, the client device 100 registers a “retrieval site” as the type, and a retrieval word as the keyword. When receiving commodity data from the server device 200b providing an electronic commerce site, the client device 100 registers a “shopping site” as the type, and a commodity name as the keyword. When reproducing a television broadcast program, the client device 100 registers a “TV program” as the type, and a program name and a performer name as the keyword.

Further, when reproducing music data, the client device 100 registers “music” as the type, and a music title and an artist name as the keyword. When reproducing video data recorded on a DVD, the client device 100 registers a “DVD” as the type, and a video title and a performer name as the keyword. When executing application software, the client device 100 registers “software” as the type, and a software name as the keyword.

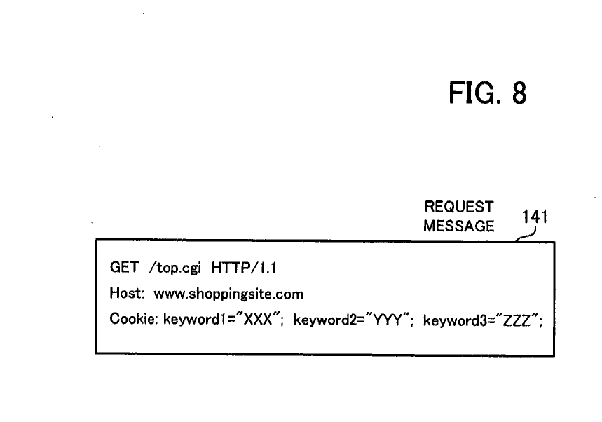

FIG. 8 illustrates a data structure of a request message. The request message 141 is a message transmitted to the server device 200 from the client device 100. In the present embodiment, the request message 141 can be mounted as an HTTP request.

The request message 141 includes a method name, a host name, a path name, and a keyword. The method name represents a name of an HTTP method used for communication, such as “GET” and “POST”. The host name represents a name allocated to a server device as a destination, and may include a domain name. The path name represents a name for distinguishing a file or data to be accessed in the server device, and may include a directory tree. A part of an address includes the host name and the path name. For example, “http://”+host name+path name corresponds to a URL.

On the other hand, the keyword can be added to the request message 141 by using various methods. In an example of FIG. 8, the client device 100 transmits the keyword as data of a cookie. In addition to the above, there are considered a method of including a keyword into path names for transmission and a method of transmitting a keyword as transmit data of a POST method. To the request message 141, multiple keywords can also be added. The multiple keywords may be ordered in the order of importance.

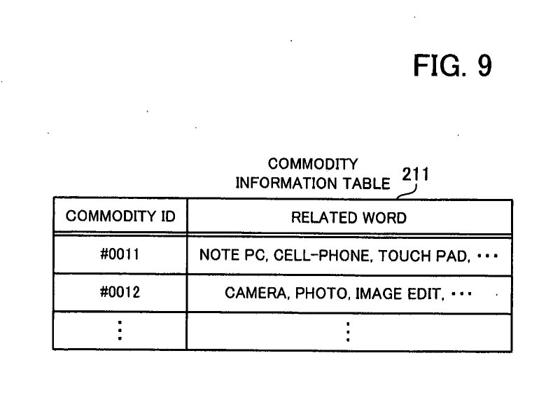

FIG. 9 illustrates a data structure of a commodity information table. The commodity information table 211 is stored in the commodity information storage unit 210 of the server device 200. In the commodity information table 211, for example, data is registered in response to operations of a manager of the server device 200.

The commodity information table 211 includes items of the commodity ID and the related word. In the item of the commodity ID, there is set an identifier for distinguishing a commodity or a type of the commodity handled in electronic commerce. In the item of the related word, there are set the one or more keywords related to commodities indicated by the commodity ID. For example, when setting multiple keywords, they are separated by commas.

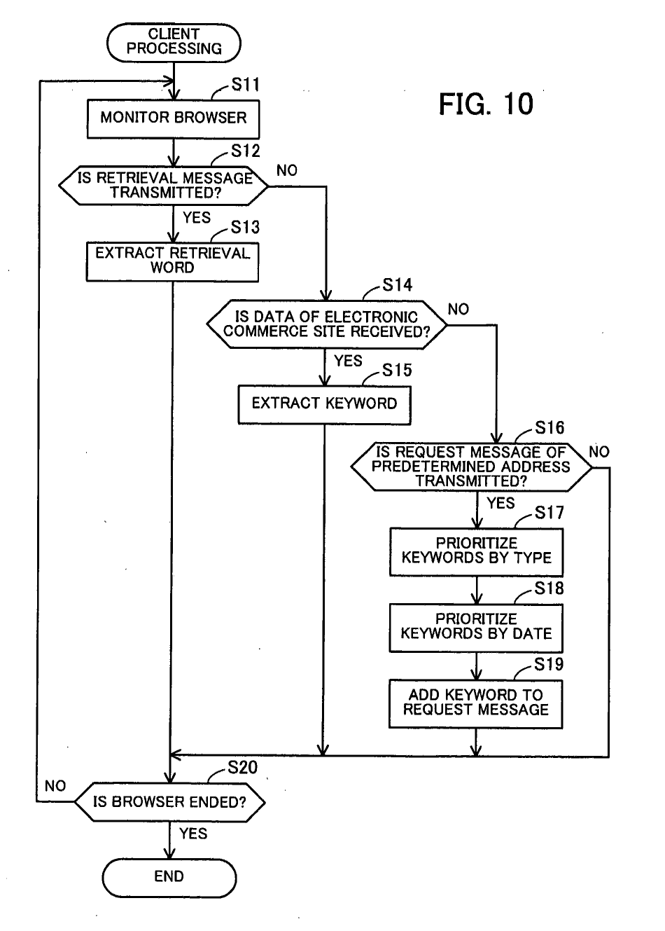

FIG. 10 is a flowchart illustrating the control of the client device. This processing is performed in the client device 100 during start of process (namely, the browser 130) of the web browser. The process illustrated in FIG. 10 includes the following steps:

(Step S11) The keyword extraction transmitter 160 starts monitoring of the browser 130. Particularly, the keyword extraction transmitter 160 monitors transmission of the HTTP request and reception of the HTTP response through the browser 130.

(Step S12) The keyword extraction transmitter 160 determines whether the browser 130 transmits the HTTP request to the server device (e.g., the server device 200a) providing a predetermined retrieval site. An address of the retrieval site to be monitored is stored in the address storage unit 110. If the relevant HTTP request is detected, the process advances to step S13. If not, the process proceeds to step S14.

(Step S13) The keyword extraction transmitter 160 extracts a retrieval word from the HTTP request detected at step S12. The keyword extraction transmitter 160 then registers the extracted retrieval word in the keyword information table 121 stored in the keyword storage unit 120 along with the type “retrieval site” and the current date.

(Step S14) The keyword extraction transmitter 160 determines whether the browser 130 receives the HTTP response from the server device (e.g., the server device 200b) providing a predetermined electronic commerce site. An address of the electronic commerce site to be monitored is stored in the address storage unit 110. If the relevant HTTP response is detected, the process advances to step S15. If not, the process proceeds to step S16.

(Step S15) The keyword extraction transmitter 160 extracts a keyword relating to commodities from the HTTP response detected at step S14. For example, the keyword is considered to be extracted from a header unit of the HTML data. The keyword extraction transmitter 160 then registers the extracted keyword in the keyword information table 121 stored in the keyword storage unit 120 along with the type “shopping site” and the current date.

(Step S16) The keyword extraction transmitter 160 determines whether the browser 130 transmits the HTTP request specifying a predetermined address. In the present embodiment, an address of the electronic commerce site provided by the server device 200 is stored in the address storage unit 110 as an address to be monitored. If the relevant HTTP request is detected, the process advances to step S17. If not, the process proceeds to step S20.

(Step S17) The keyword extraction transmitter 160 prioritizes keywords registered in the keyword information table 121 based on the type. Priority of the type may be previously specified by the user, or may be determined based on an execution frequency of the application software of each type. For example, as the type is more frequently-executed, a priority is set to be higher. The execution frequency can be determined from data registered in the keyword information table 121, or can be determined by separately monitoring a process of the client device 100.

(Step S18) The keyword extraction transmitter 160 further prioritizes keywords of the same type based on the date. For example, as a keyword has newer date, a priority is set to be higher. A keyword after the elapse of a predetermined period (e.g., one week) or more from the registration may be excluded from transmission candidates. Further, the above-described keyword after the elapse of the predetermined period or more may be erased from the keyword information table 121.

The keyword extraction transmitter 160 may perform the processing of steps S17 and S18 in reverse order, prioritize the date, and perform the priority of keywords. For example, the keyword extraction transmitter 160 may divide elapsed time from the registration into multiple sections (e.g., less than one day, one day or more and less than three days, and three days or more) for the priority. The keyword extraction transmitter 160 may further prioritize keywords belonging to the same section based on the type.

(Step S19) The keyword extraction transmitter 160 adds a part or all of the keywords prioritized at steps S17 and S18 to the HTTP request detected at step S16. For example, the keyword extraction transmitter 160 selects a predetermined number (e.g., five) of keywords from the high priority and adds them to the HTTP request. On that occasion, the keyword extraction transmitter 160 can add them to the HTTP request in conjunction with information on the priority of each keyword.

(Step S20) The keyword extraction transmitter 160 determines whether an operation of the browser 130 ends (a process of the web browser ends). If the operation ends, the keyword extraction transmitter 160 ends monitoring of the browser 130. If not, the process returns to step S11.

The above steps permit the client device 100 to extract keywords from transmit/receive data during usage of the retrieval site and the electronic commerce site. Through the above steps, the client device 100 can collect a keyword featuring an interest of the user. Further, the client device 100 automatically transmits a part or all of the accumulated keywords during access to the server device 200. As a result, the server device 200 can know an interest of the user.

The client device 100 may add the keyword to the HTTP request specifying an arbitrary address of the electronic commerce site, or to only the HTTP request specifying a specific address (e.g., a root address) of the electronic commerce site. Further, when continuously accessing the same electronic commerce site more than once, specifically, when continuously transmitting the HTTP request specifying an address of the electronic commerce site more than once, the client device 100 may add a keyword to only the first HTTP request.

In the extraction processing of the above steps S11 to S15 and the transmission processing of the above steps S16 to S19, separate processes may be performed in parallel. Further, the extraction processing of the keyword can be performed also by the keyword extraction unit 170 in parallel to the processing through the above-described keyword extraction transmitter 160. Note that the extraction processing of the keyword may be stopped during performance of the transmission processing of the above steps S16 to S19, or during access to the electronic commerce site to be transmitted.

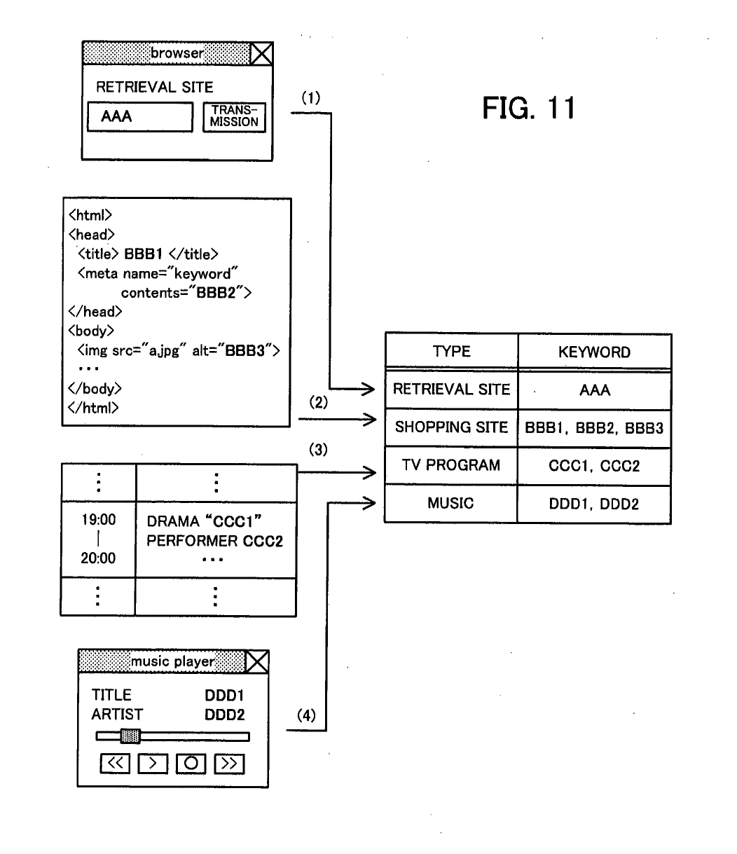

FIG. 11 illustrates an extraction example of the keyword. FIG. 11 illustrates (1) an extraction example during usage of the retrieval site, (2) an extraction example during usage of the electronic commerce site, (3) an extraction example during viewing of the television broadcast program, and (4) an extraction example during reproduction of the music data. Note that the keyword can also be extracted by a method except the method illustrated in FIG. 11.

(1) During retrieval site usage

When the user inputs a retrieval word “AAA” and depresses a transmission button, the keyword extraction transmitter 160 acquires the retrieval word “AAA”. Through the above processing, the type “retrieval site” and the keyword “AAA” are registered in the keyword information table 121.

(2) During electronic commerce site usage

When the user browses a web page for introducing commodities, the keyword extraction transmitter 160 acquires the title “BBB1” of a web page and the keyword “BBB2” in a metatag of the HTML data. In addition, the keyword extraction transmitter 160 acquires the description “BBB3” given to a commodity image. Through the above processing, the type “shopping site” and the keywords “BBB1, BBB2, and BBB3” are registered in the keyword information table 121.

(3) During television broadcast program viewing

When the user views a television broadcast program, the keyword extraction unit 170 acquires the program title “CCC1” and the performer name “CCC2”. Through the above processing, the type “TV program” and the keywords “CCC1 and CCC2” are registered in the keyword information table 121.

(4) During music data reproduction

When the user reproduces music data stored in the HDD 103, the keyword extraction unit 170 acquires the music title “DDD1” and the artist name “DDD2”. Through the above processing, the type “music” and the keywords “DDD1 and DDD2” are registered in the keyword information table 121.

The keyword extraction transmitter 160 and the keyword extraction unit 170 can also extract keywords from sentences or phrases. For example, the keyword extraction transmitter 160 and the keyword extraction unit 170 perform a morphological analysis or syntax analysis with respect to sentences, thereby extracting keywords. Further, the keyword extraction transmitter 160 and the keyword extraction unit 170 may set as an NG word a general term failing to feature an interest of the user, and the NG word may eliminate the need to be extracted.

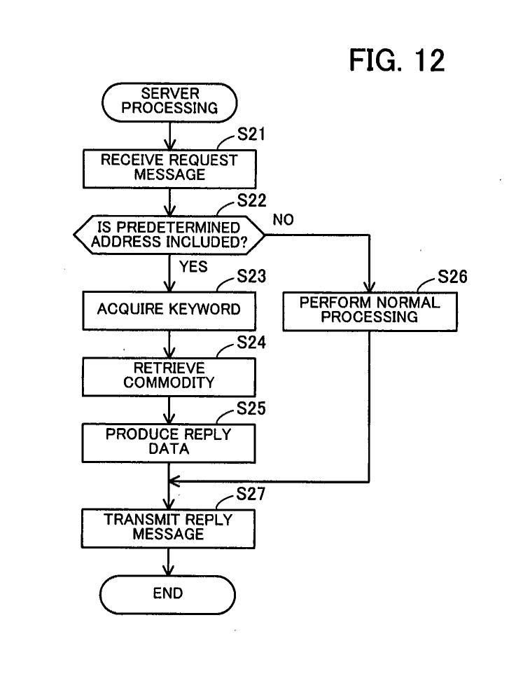

FIG. 12 is a flowchart illustrating the control of the server device. When receiving the HTTP request from the client device 100, the server device 200 performs this processing. The process illustrated in FIG. 12 includes the following steps:

(Step S21) The request reception unit 230 receives the HTTP request transmitted by the client device 100 via the network 21.

(Step S22) The request reception unit 230 determines whether a predetermined address (e.g., a root address of the electronic commerce site) is included in the HTTP request received at step S21. The above-described determination can be performed, for example, based on a path name. If the predetermined address is included in the HTTP request, the process advances to step S23. If not, the process proceeds to step S26.

(Step S23) The request reception unit 230 extracts a keyword from the HTTP request received at step S21. The request reception unit 230 then supplies the extracted keyword to the retrieval unit 240.

(Step S24) The retrieval unit 240 checks the keyword acquired from the request reception unit 230 with the related word of the commodity information table 211 stored in the commodity information storage unit 210, thereby selecting a commodity adapted to the acquired keyword. The retrieval unit 240 may narrow the selected commodity to a predetermined number or less.

As a method of selecting a commodity, various methods are considered. For example, there is considered a method of selecting a commodity having a related word completely or partially matched with the keyword. When multiple keywords are acquired, a commodity may have as conditions a related word corresponding to all the keywords or at least one of the keywords. As conditions, a rate of the corresponding related word may be larger than a predetermined threshold. When the priority is given to the keyword, weighting may be performed depending on the priority.

(Step S25) The retrieval unit 240 acquires data on the commodity selected at step S24 from the commodity information storage unit 210. The retrieval unit 240 further acquires the HTML template corresponding to an address included in the HTTP request from the template storage unit 220. The retrieval unit 240 then embeds text data as commodity data in the HTML template to produce the

HTML data, and supplies it to the request reception unit 230. The process then proceeds to step S27.

(Step S26) The request reception unit 230 and the retrieval unit 240 perform normal processing according to an address included in the HTTP request. In the case of an address corresponding to the commodity classification, for example, the retrieval unit 240 produces HTML data indicating the commodity classification list, and supplies the HTML data to the request reception unit 230. On the other hand, in the case of an address corresponding to separate commodity, the retrieval unit 240 produces HTML data indicating a detail of the commodity, and supplies the HTML data to the request reception unit 230.

(Step S27) The request reception unit 230 adds an HTTP header to the data acquired from the retrieval unit 240 to produce an HTTP response, and transmits it to the client device 100.

Through the above steps, the server device 200 retrieves a commodity adapted to the keyword when receiving the HTTP request including the keyword from the client device 100. Then, in addition to data explicitly requested by the HTTP request, the server device 200 transmits also data on the commodity adapted to the keyword to the client device 100. This feature of the server device 200 presents a commodity considered to have a high interest of the user.

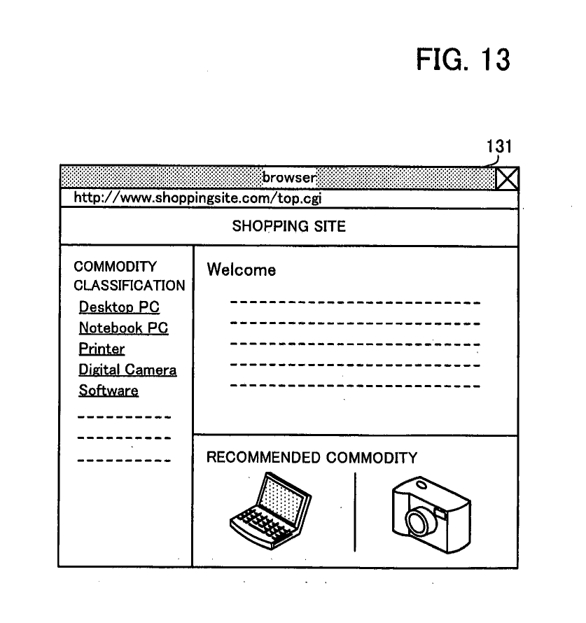

FIG. 13 illustrates a display screen example. The display screen 131 illustrates an example of a screen displayed on the display 11 after the browser 130 accesses the server device 200. As illustrated in FIG. 13, when specifying and accessing a root address “http://www.shoppingsite.com/top.cgi” of the electronic commerce site, there is displayed a web page including a region of the commodity classification and that of the recommended commodity.

In the region of the commodity classification, displayed is a commodity classification item as in “Desktop PC” or “Notebook PC”. To each commodity classification item, a hyperlink is given. The user can find out a desired commodity when following a hyperlink from the commodity classification list. On the other hand, on the region of the recommended commodity, there is displayed data on a commodity corresponding to the keyword automatically transmitted to the server device 200 from the client device 100. The user can skip an operation for finding out a desired commodity and proceed to a procedure for purchasing the commodity when the recommended commodity is a commodity with high interest of its own.

In the above-described electronic commerce system of the present embodiment, the client device 100 can collect keywords based on execution situations of information processing, namely, keywords featuring an interest of the user. When using the electronic commerce site, the client device 100 can automatically transmit the collected keywords. As a result, presentation of the commodity considered to have a high interest of the user can be first received. Particularly, at the stage before the user performs an operation for finding out the commodity, such as during the access to a front page of the electronic commerce site, the presentation of the above-described commodity can be received.

Accordingly, the user can comfortably use the electronic commerce site. Also in an operator side of the electronic commerce site, a buying intention of the user can be promoted. Particularly, in the method according to the present embodiment, an appropriate commodity can be presented also to the user having poor use results of the electronic commerce site. Consequently, it is considered that an operator of the electronic commerce site distributes a program for realizing the above processing to users for the use of the electronic commerce site. For example, the server device 200 may transmit the above-described program to the client device 100.

As described before, processing functions of the client device 100 and the server device 200 can be realized by a general-purpose computer. In that case, a program describing contents of the processing function is provided. The program describing contents of the processing function can be recorded on a computer-readable recording medium. Examples of the recording medium include a magnetic disk, an optical disk, a magneto-optical disk (MO), and a semiconductor memory. Examples of the magnetic disk include an HDD, an FD, and a magnetic tape (MT). Examples of the optical disk include a CD, a CD-Recordable/Rewritable (CD-R/RW), a DVD, and a DVD-R/RW.

When programs are circulated on markets, for example, a portable recording medium on which the programs are recorded is provided. Or, the programs can also be circulated by storing the programs in a storage device of another computer, and transferring the stored programs from the other computer to a computer which executes the programs via a network.

The computer which executes the programs stores the programs recorded on the portable recording medium or the programs received from the other computer in its own storage device, for example. The computer reads the programs from its own storage device and executes processing in accordance with the programs. Alternatively, the computer can execute processing in accordance with the programs by directly reading the programs from the portable recording medium. Whenever the programs are received from the other computer, the computer can sequentially execute processing in accordance with the received program.

According to the above-described information processing apparatus, communication control method, and communication control program, desired data of users can be easily acquired from a server device.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that various changes, substitutions, and alterations could be made hereto without departing from the spirit and scope of the invention.

What is claimed is:

1. An information processing apparatus comprising:
a storage unit configured to store a keyword according to executed information processing;
a communication unit configured to transmit a message specifying a server device as a destination and receive data according to the message from the server device via a network; and
a controller configured to add at least one of the keywords stored in the storage unit to a message to a predetermined server device among the messages transmitted by the communication unit.

2. The information processing apparatus according to claim 1, wherein:
the storage unit stores information indicating a type of the information processing correspondingly to the keyword; and
the controller selects a keyword added to the message based on the type of the information processing.

3. The information processing apparatus according to claim 1, wherein:
a communication with another server device different from the predetermined server device is included in the information processing; and
the controller extracts the keyword from messages to said another server device or data received from said another server device and stores the extracted keyword in the storage unit.

4. The information processing apparatus according to claim 1, wherein:
reproduction of music data or video data is included in the information processing; and
the controller extracts the keyword from attribute data of the reproduced music data or video data and stores the extracted keyword in the storage unit.

5. The information processing apparatus according to claim 1, wherein the communication unit receives data selected based on the keyword added to the message among data managed by the predetermined server device from the predetermined server device.

6. The information processing apparatus according to claim 5, wherein:
the communication unit further receives, when transmitting a message including a predetermined address, screen data used for an operation of retrieval with respect to data managed by the predetermined server device; and
the controller receives a reply to a message including the predetermined address, and displays a screen including a first region for operating the retrieval and a second region indicating data selected based on the keyword.

7. A communication control method of an information processing apparatus connected to a network, the method comprising:
detecting executed information processing, extracting a keyword according to the information processing, and storing the extracted keyword in a storage unit of the information processing apparatus;
adding at least one of the keywords stored in the storage unit to a message to a predetermined server device among messages transmitted via the network; and
receiving data based on the keyword added to the message from the predetermined server device via the network.

8. A non-transitory computer-readable medium storing a communication control program for causing a computer connected to a network:
to detect executed information processing, extract a keyword according to the information processing, and store the extracted keyword in a storage unit of the computer;
to add at least one of the keywords stored in the storage unit to a message to a predetermined server device among messages transmitted via the network; and
to receive data based on the keyword added to the message from the predetermined server device via the network.
